(19) United States
(12) Patent Application Publication
(10) Pub. No.: US 2005/0279874 A1
(43) Pub. Date: Dec. 22, 2005

(54) Tape reel assembly with uniformly deforming tape-winding surface

(75) Inventors: Robert C. Martin, St. Paul, MN (US); Arne B. Boberg, Shoreview, MN (US); G. Phillip Rambosek, Shafer, MN (US); Peter A. Ridl, Oakdale, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/870,264

(22) Filed: Jun. 17, 2004

(51) Int. Cl. G11B 23/107

(52) U.S. Cl. 242/348

(57) ABSTRACT

A tape reel assembly for use in a tape drive system for winding and unwinding storage tape is described. The tape reel assembly has a hub including a cylindrical core, an annular wall, and a web connecting the annular wall to the cylindrical core. The annular wall is co-axially disposed exterior to and separated from the cylindrical core and defines a tape-winding surface. The web extends between the annular wall and the cylindrical core and defines a first surface and a second surface. In this regard, at least one of the first surface and the second surface is shaped to approximate a sinusoid in radial cross-section.

### THE FIELD OF THE INVENTION

The present invention relates to a tape reel assembly for use in a tape drive system. More particularly, it relates to a tape reel assembly having a uniformly deforming tape winding surface.

### BACKGROUND OF THE INVENTION

Data storage tape systems have been used for decades in the computer, audio, and video fields. The data storage tape system includes a tape drive and one or more data storage tape cartridges. During use, tape from the cartridge is driven by a tape drive system defined by one or both of the cartridge and tape drive. Regardless of exact form, the data storage tape system continues to be a popular format for recording large volumes of information for subsequent retrieval and use.

With the above in mind, a data storage tape cartridge generally consists of an outer shell or housing maintaining at least one tape reel assembly and a length of magnetic storage tape. The storage tape is wrapped about a hub portion of the tape reel assembly and is driven through a defined path by a driving system. The housing normally includes a separate cover and a separate base. Together, the cover and base form an opening (or window) at a forward portion thereof permitting access to the storage tape by a read/write head upon insertion of the data storage tape cartridge into the tape drive. The interaction between the storage tape and head can occur within the housing (i.e., a mid-tape load design) or exterior to the housing (i.e., a helical drive design). Where the head/storage tape interaction is exterior to the housing, the data storage tape cartridge normally includes a single tape reel assembly employing a leader block. Alternately, where the head/storage tape interaction is within the housing, a dual tape reel configuration is typically employed.

Regardless of the number of tape reel assemblies associated with a particular data storage tape cartridge, the tape reel assembly itself is generally comprised of three basic components: an upper flange, a lower flange, and a hub. In general, the hub includes an outer cylindrical ring and internal support material. The outer cylindrical ring defines a tape-winding surface about which the storage tape is wound. The internal support material forms a central region of the hub and facilitates assembly of the hub (e.g., over a pin and/or connection with a separate drive chuck). The flanges are optional and, if employed, are disposed at opposite ends of the hub and spaced apart to accommodate a width of the storage tape. To reduce the likelihood of the storage tape undesirably contacting one of the flanges during a winding operation, the flange-to-flange spacing is selected to be slightly greater than the width of the tape.

The storage tape is wrapped onto the tape-winding surface. Winding successive layers of storage tape onto the hub creates a compressive force that will eventually cause the tape-winding surface to deflect radially inward. Unfortunately, many prior art tape reel assemblies have tape-winding surfaces that deform in a non-uniform manner. In particular, the prior art tape reel assemblies have inadequately accounted for the distribution of the compressive force arising from the wrapped storage tape. Unequal distribution of the compressive force at the tape-winding surface can deleteriously affect winding and unwinding of the storage tape. For example, an unequal distribution of the compressive forces can cause the deformation of the prior art tape winding surfaces to vary widely, deflecting more near the upper flange, for instance, and less near the lower flange (or vice versa). One consequence of this skewed deformation of the tape-winding surface is a skewing of the storage tape during winding and unwinding. Significantly skewed or non-symmetric deformation of the tape-winding surface can deform the storage tape and lead to read/write errors. As a point of reference, skewed storage tape is characterized by non-uniform storage tape tension, resulting in a poor head-to-tape interface. Similar concerns can arise with tape reel assemblies provided as part of the tape drive (such as with a tape drive adapted to operate a single reel cartridge). Tape reel assemblies used within tape drives are commonly referred to as tape drive spools or take-up reels.

Tape reel assemblies are typically formed from plastic components. Though cost effective, plastic hubs deform under the compressive forces associated with successive windings of storage tape. If the deformation is not symmetric, the storage tape experiences non-uniform tension. Consumers generally prefer storing as much information as possible in one data storage tape cartridge. This consumer preference translates to wrapping more and more storage tape on a tape reel assembly/assemblies. In the case of a single reel data storage tape cartridge, all of the storage tape is by necessity wound about only one reel. The large number of tape windings directly correlates to a large radial tape winding force. Accordingly, tape reel assemblies, and, in particular, single reel assemblies, are vulnerable to skewed deformation of the tape-winding surface which can contribute to read/write errors and other tape tracking errors.

One attempt to limit tape winding surface deformation has been to provide discrete structural ribs opposite the tape-winding surface (i.e., as part of the internal support material). The location and geometry of these ribs is constrained by placement of other features of the hub (e.g., brake and drive interfaces) and by limitations in the molding process. If the ribs are designed with a cross-section that is thick relative to the cylindrical wall that forms the tape winding surface, the ribs can distort the tape winding surface by creating a sink region inherent to the molding process. This molding sink has been shown to cause distortion of the tape-winding surface even in the absence of tape winding surface deformation. If the ribs are designed with a cross-section that is thin relative to the wall that forms the tape winding surface, the tape winding surface is inadequately supported by the ribs. Under the stress of multiple storage tape wraps, the tape-winding surface can deform in a skewed manner.

Tape reel assemblies will continue to be employed in tape drives and data storage tape cartridges. With increasing speeds of reading/writing and advanced magnetic tape technology, design of the tape reel assembly is directed to providing accurate and consistent storage tape positioning. To this end, skewed deformation of the tape-winding surface can result in deformation of the storage tape, creating errors in reading from, and writing to, the storage tape. Therefore, a need exists for a tape reel assembly configured to provide uniform deformation of the tape winding surface.

### SUMMARY OF THE INVENTION

One aspect of the present invention relates to a tape reel assembly for use in a tape drive system for winding and unwinding storage tape. The tape reel assembly has a hub including a cylindrical core, an annular wall, and a web. The annular wall is co-axially disposed exterior to and separated from the cylindrical core and defines a tape-winding surface. The web extends between the annular wall and the cylindrical core and defines a first surface and a second surface. In this regard, at least one of the first surface and the second surface is shaped to approximate a sinusoid in radial cross-section.

Another aspect of the present invention relates to a data storage tape cartridge. The data storage tape cartridge includes a housing defining an enclosed region, at least one tape reel assembly rotatably disposed within the enclosed region, and a storage tape. The tape reel assembly includes a hub having a cylindrical core, an annular wall, and a web. The annular wall is co-axially disposed exterior to and separated from the cylindrical core and has a first end and a second end. In addition, the annular wall defines a tape-winding surface. The web extends between the annular wall and the cylindrical core. The storage tape is configured to wind about the tape-winding surface. In this regard, the web is shaped to approximate a sinusoid in radial cross-section.

Yet another aspect of the present invention relates to a method of manufacturing a tape reel assembly for use in a tape drive system for winding and unwinding storage tape. The method includes forming a cylindrical core. The method additionally includes forming an annular wall. The annular wall is co-axially disposed exterior to and separated from the cylindrical core, the annular wall having a first end and a second end, and defining a tape-winding surface. The method further includes forming a web. The web extends between the annular wall and the cylindrical core and has a first surface and a second surface. The method ultimately includes configuring at least one of the first surface and the second surface of the web to undulate between the first and second ends of the annular wall.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a single reel data storage tape cartridge showing a tape reel assembly;

FIG. 2 is an exploded view of a three-piece tape reel assembly including a hub according to one embodiment of the present invention;

FIG. 3 is a perspective view of the hub shown in FIG. 2;

FIG. 4 is a cross-sectional view of the hub shown in FIG. 3; and

FIG. 5 is a cross-sectional view of the hub shown in FIG. 3 with a portion of an annular wall removed for viewing clarity.

### DETAILED DESCRIPTION OF THE PREFERRED EMBODIMENTS

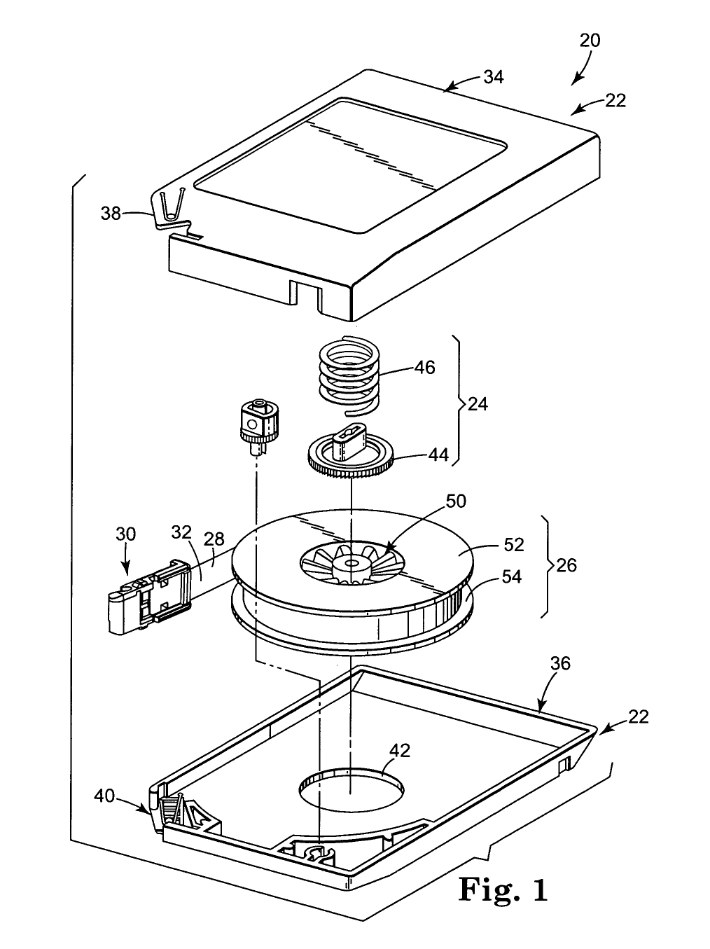

The present invention relates to a tape reel assembly useful as part of a tape drive system component, such as a data storage tape cartridge or a tape drive. To this end, an exemplary single reel data storage tape cartridge according to one embodiment of the present invention is illustrated at 20 in FIG. 1. Generally, the data storage tape cartridge 20 includes a housing 22, a brake assembly 24, a tape reel assembly 26, a storage tape 28, and a leader block 30. The tape reel assembly 26 is disposed within the housing 22. The storage tape 28, in turn, is wound about the tape reel assembly 26 and includes a leading end 32 attached to the leader block 30. As a point of reference, while a single reel data storage tape cartridge 20 is shown, the present invention is equally applicable to other cartridge configurations, such as a dual reel cartridge.

The housing 22 is sized to be received by a typical tape drive (not shown). Thus, the housing 22 exhibits a size of approximately 125 mm×110 mm×21 mm, although other dimensions are equally acceptable. With this in mind, the housing 22 is defined by a first housing section 34 and a second housing section 36. In one embodiment, the first housing section 34 forms a cover whereas the second housing section 36 forms a base. As used throughout the specification, directional terminology such as “cover,” “base,” “upper,” “lower,” “top,” “bottom,” etc., is employed for purposes of illustration only and is in no way limiting.

The first and second housing sections 34 and 36, respectively, are sized to be reciprocally mated to one another and are generally rectangular, except for one corner 38 that is preferably angled and forms a tape access window 40. The tape access window 40 serves as an opening for the storage tape 28 to exit from the housing 22 such that the storage tape 28 can be threaded to a tape drive (not shown) when the leader block 30 is removed from the tape access window 40. Conversely, when the leader block 30 is engaged in the tape access window 40, the tape access window 40 is covered.

In addition to forming a portion of the tape access window 40, the second housing section 36 also forms a central opening 42. The central opening 42 facilitates access to the tape reel assembly 26 by a drive chuck portion of the tape drive (not shown). During use, the drive chuck portion disengages the brake assembly 24 prior to rotating the tape reel assembly 26 for access to the storage tape 28. The brake assembly 24 is of a type known in the art and generally includes a brake 44 and a spring 46 co-axially disposed within the tape reel assembly 26. When the data storage tape cartridge 20 is idle, the brake assembly 24 is engaged to selectively “lock” the single tape reel assembly 26 to the housing 22.

The storage tape 28 is preferably a magnetic tape of a type commonly known in the art. For example, the storage tape 28 may consist of a balanced polyethylene naphthalate (PEN) based material coated on one side with a layer of magnetic material dispersed within a suitable binder system and coated on the other side with a conductive material dispersed within a suitable binder system. Acceptable magnetic tape is available, for example, from Imation Corp. of Oakdale, Minn.

The leader block 30 covers the tape access window 40 and facilitates retrieval of the storage tape 28. In general terms, the leader block 30 is shaped to conform to the window 40 of the housing 22 and to cooperate with the tape drive (not shown) by providing a grasping surface for the tape drive to manipulate in delivering the storage tape 28 to the read/write head. In this regard, the leader block 30 can be replaced by other components, such as a dumb-bell shaped pin. More over, the leader block 30, or a similar component, can be eliminated entirely, such as with a dual reel cartridge design.

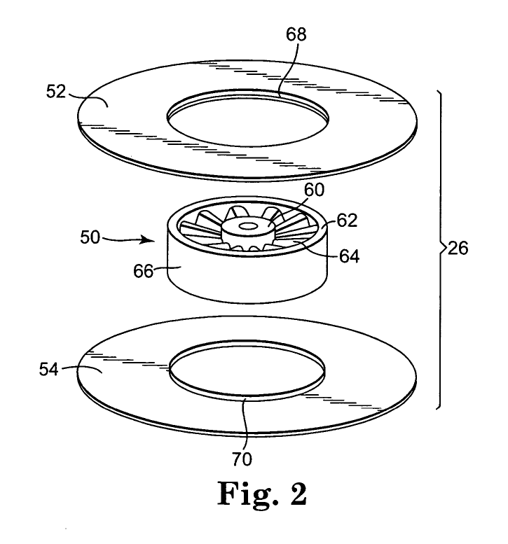

The present invention as more fully described below is beneficially employed with either a single tape reel assembly or a multiple tape reel assembly cartridge design, and is not limited to single tape reel cartridge designs. With this in mind, and with reference to FIG. 1, the tape reel assembly 26 comprises a hub 50, an upper flange 52, and a lower flange 54. The upper and lower flanges 52, 54 extend in a radial fashion from opposing sides of the hub 50, respectively. In one embodiment, the hub 50 and the flanges 52, 54 cooperate to retain multiple wraps of the storage tape 28 around the hub 50 and between the flanges 52, 54. Notably, where the cartridge 20 is a belt driven design, the opposing flanges 52, 54 are not necessary to maintain the storage tape 28, and can, therefore, be eliminated. In the broadest sense then, the tape reel assembly 26 can comprise the hub 50 alone. The tape reel assembly 26 is more completely described with reference to FIG. 2 below.

The tape reel assembly 26 in accordance with one embodiment of the present invention is illustrated in the exploded view in FIG. 2. The tape reel assembly 26 includes the hub 50, the upper flange 52, and the lower flange 54. The hub 50 includes a cylindrical core 60, an annular wall 62, and a web 64. The annular wall 62 is co-axially disposed exterior to, and separated from, the cylindrical core 60 and defines a tape winding surface 66. In one embodiment, the hub 50 is manufactured separately from the opposing flanges 52, 54 that are subsequently attached to the hub 50. In this regard, a first interior edge 68 is provided on the upper flange 52, and a second interior edge 70 is provided on the lower flange 54. The interior edges 68, 70 of the upper and lower flanges 52, 54 are configured for attachment to the annular wall 62. Alternately, the hub 50 and the opposing flanges 52, 54 can be integrally formed. Finally, though hidden in the view of FIG. 2, the tape reel assembly 26 can further include drive teeth extending downwardly (relative to the orientation of FIG. 2) from the hub 50 and/or the lower flange 54.

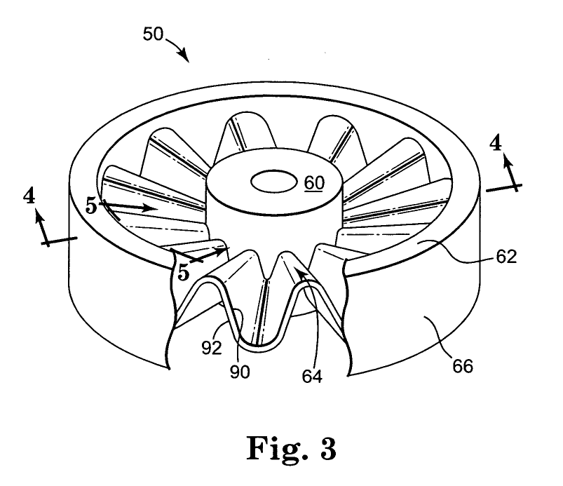

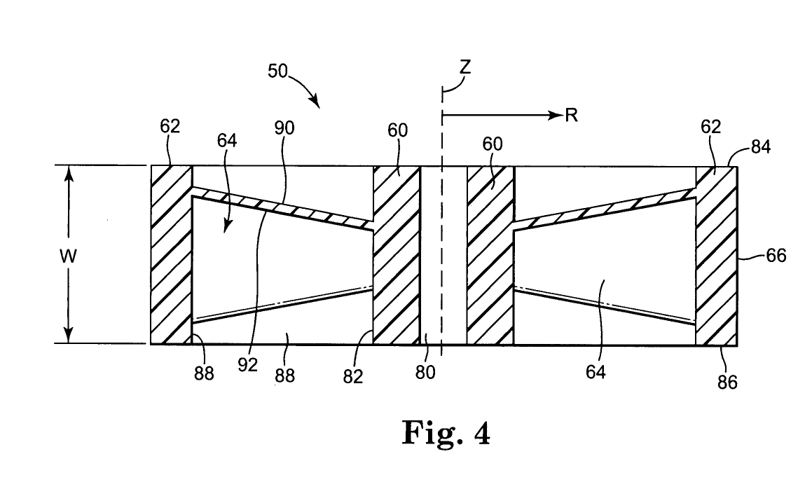

The hub 50 according to one embodiment of the present invention is illustrated in a perspective view in FIG. 3. The hub 50 includes the cylindrical core 60, the annular wall 62, and the web 64. The web 64 extends between or connects the cylindrical core 60 and the annular wall 62. In particular, the web 64 undulates in radial cross-section and is configured to support the tape winding surface 66 by distributing the stress applied thereto, as described with reference to FIGS. 3 and 4 below.

FIG. 3 is a perspective view and FIG. 4 is a cross-sectional view of the hub 50. With reference to FIG. 4, the cylindrical core 60 defines an axial bore 80 and an exterior surface 82. The axial bore 80 is centered about an axis Z. A radius R defines a radial distance from the Z axis. The annular wall 62 has a first end 84 and a second end 86 separated by a width W along which the tape winding surface 66 extends. Additionally, the annular wall 62 defines an interior surface 88 opposite the tape winding surface 66. The web 64 extends between the exterior surface 82 of the core 60 and the interior surface 88 of the annular wall 62. With reference now to FIGS. 3 and 4, the web 64 defines a first surface 90 and a second surface 92. In accordance with the present invention, at least one of the first and second surfaces 90, 92, preferably both, undulates to define a sinusoid in radial cross-section.

In one embodiment, the web 64 undulates between the first and second ends 84, 86, respectively, to support the tape winding surface 66. In another embodiment, the web 64 undulates across the entire width W of the annular wall 62. In an alternate embodiment, as shown in FIG. 4, the web 64 undulates across a portion of the width W of the annular wall 62. The width W will vary according to the design style of the hub 50 (i.e., the hub 50 can be a single reel hub, a dual reel hub, a hub with, or without, flanges, a belt driven hub, etc.). In general, however, the width W is in the range of 0.25-4 inches. The undulation or oscillation of the web 64 is described in detail below.

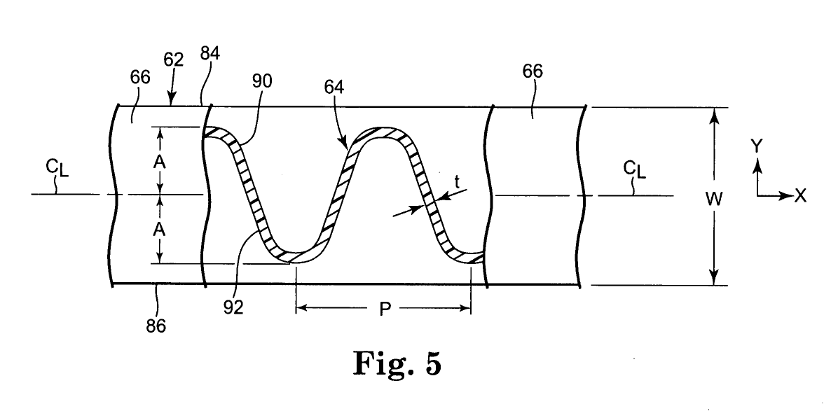

FIG. 5 is a cross-sectional view illustrating one preferred conformation of the web 64. As shown in FIG. 5, a section of the annular wall 62 has been removed to provide a view of the web 64. A centerline C_{L} is defined that bisects the annular wall 62. The centerline C_{L} provides a reference line over which an orthogonal reference plane X, Y is imposed for descriptive clarity. In this regard, the web 64 defines the first surface 90 and the second surface 92 separated by a thickness t. The web 64 undulates across a portion of the width W characterized by an amplitude A and a period of undulation P. Specifically, at least one of the surfaces 90, 92 (preferably both) of the web 64 shown in FIG. 5 are shaped to approximate a sinusoid in radial cross-section. That is to say, the web 64 oscillates, or translates, between the ends 84, 86 of the annular wall 62. In particular, the surfaces 90, 92 can approximate a sinusoid in radial cross-section such that the surfaces 90, 92 define a shape that is sinusoid-like (i.e., wave-shaped, sawtooth-shaped, a shape with peaks-and-valleys, a shape defined by circular arcs at the peaks/valleys connected by lines). In one embodiment, the surfaces 90, 92 are shaped to approximate a sinusoid in radial cross-section such that a sinusoid having selected amplitudes A and periods of undulation P, as described below, is formed. In this manner, a wide range of sinusoid-like shapes (including sinusoid shapes, sawtooth shapes, and wavy shapes) can be formed by the surfaces 90, 92.

For example, and as shown in FIG. 5, the shape of the surfaces 90, 92 is a sinusoid that corresponds generally to the trigonometric relationship Y=A Sin CX, where the period of undulation P is given by 2 π/C. π is defined to be the ratio of a circle's circumference to the circle's diameter, as known in the art. C can be any real number, or a function that results in a real number. For C=2 π , the period of undulation P is equal to 1. For large values of C, for example C>6 π, the period P becomes small such that the undulations are rapid. That is to say, for large values of C, the surfaces 90, 92 oscillate rapidly, thus forming a sinusoid shape that approximates a sawtooth pattern.

The amplitude A is measured as a distance from the centerline C_{L} to the surfaces 90, 92, as oriented in FIG. 5. The amplitude A, representing a magnitude of undulation of the web 64, can vary as a function of the radial distance R (FIG. 4). In particular, it is desired that the amplitude A be sized such that the web 64 spans across as much of the interior surface 88 as possible, while optionally affording clearance for assembly of the flanges 52, 54. Thus, as shown in FIG. 5, the amplitude A is in the range of W/3 to W/2 at a point where the radial distance R is taken at the interior surface 88. In an alternate embodiment, the amplitude A is approximately W/2 at a point where the radial distance R is taken at the interior surface 88, such that the web 64 supportively spans the width W of the interior surface 88. In addition, as best shown in FIG. 4, the amplitude A is approximately W/5 for the radial distance R taken at the exterior surface 82 of the cylindrical core 60. Thus, in one embodiment, the amplitude A of the undulating web 64 varies linearly between the annular wall 62 and the cylindrical core 60 in such a manner that the web 64 supports a majority of the width W of the annular wall 62.

In another embodiment, the amplitude A of the undulating web 64 is constant across the radial length R of the web 64. Hence, the magnitude of the amplitude A is the same adjacent the annular wall 62 as it is adjacent the cylindrical core 60. In an alternate embodiment, the amplitude A is approximately W/2 adjacent the annular wall 62 and the amplitude A is approximately 0 adjacent the cylindrical core 60. That is to say, the web 64 undulates adjacent the annular wall 62 but does not undulate adjacent the cylindrical core 60. In any regard, it is preferred that the undulating web 64 has an amplitude A of approximately W/2 adjacent the annular wall 62 such that stress applied to the tape winding surface 66 is equally and uniformly distributed by the web 64.

The period P represents the distance along the X-axis over which one full cycle oscillation (i.e., undulation) occurs. The period P can be selectively varied. For example, the period P can be short such that the web 64 incorporates many full cycle oscillations in a given distance (i.e., like a sawtooth pattern). For example, in one embodiment, the period P is 0.5 inch such that the web 64 undulates four cycles in a circumferential distance along the annular wall 62 of 2 inches. Alternately, the period P can be long such that the web 64 incorporates only one full cyclical oscillation in the given distance. For example, in another embodiment, the period P is 2 inches such that the web 64 undulates one cycle in a circumferential distance along the annular wall 62 of 2 inches.

The thickness t is defined to be the distance between the first surface 90 and the second surface 92 of the web 64. In general terms, it is preferred that the thickness t be less than 0.25 inch. In particular, for a relatively large thickness t (i.e., on the order of the same thickness as the annular wall 62), a deleterious molding sink can occur in the web 64 during a forming process. That is to say, webs 64 having the thickness t greater than approximately 0.25 inch require great amounts of cooling. Cooling of thick webs 64 can result in unequal cooling of the hub 50, causing warping of the tape winding surface 66.

In one embodiment, the thickness t is selected to be constant across the web 64. In an alternate embodiment, the thickness t is non-constant across the web 64. Specifically, the thickness t can be configured to be thicker adjacent the cylindrical core 60 and thinner adjacent the annular wall 62. In one embodiment, the thickness t is selected to be in the range of 0.005-0.100 inch, more preferably in the range of 0.02-0.08 inch, and most preferably the thickness t is selected to be approximately 0.04 inch. Significantly, the thickness t is selected such that the web 64 provides adequate support to the tape winding surface 66 without creating a deleterious molding sink region during the hub 50 forming process.

During use, winding of the storage tape 28 (FIG. 1) onto the hub 50 places a compressive radial load (due to an increase in radial pressure from each successive tape wrap) upon the tape winding surface 66. Prior art tape reel assemblies inadequately distribute the compressive winding stress and, accordingly, the prior art tape reel assemblies exhibited skewed deformation of the tape-winding surface. In contrast, the present invention provides support to the tape winding surface 66 by configuring the web 64 to undulate between a portion of the width W of the annular wall 62. Specifically, the web 64 supports and distributes the radial stress applied to the tape winding surface 66 by successive windings of storage tape 28 resulting in approximately uniform radial deformation of the tape winding surface 66. In one exemplary embodiment, a hub was formed of 20% glass-filled polycarbonate and subjected to a load of approximately 400 pounds per square inch. An undulating web was provided having the following structure. The amplitude A was selected to be W/2, corresponding to 0.25 inch. The period P was selected to be 1 inch to achieve 12 full cycle oscillations of the sinusoidal web about the circumference of the hub. The thickness t of the web was selected to be 0.040 inch. The web distributed the load such that the tape winding surface exhibited maximum radial deformation of approximately 0.0013 inch and non-uniform radial deformation (defined as the difference between the maximum and minimum deformation) of approximately 0.00015 inch. As employed in this detailed description, “approximately uniform radial deformation” along the tape winding surface 66 is defined to mean a variation in the deformation of the tape winding surface 66 along an axial length thereof of not more than 0.0005 inch per 100 psi of radial pressure, as determined, for example, by finite element analysis or other testing techniques. That is to say, the radial deformation of the tape winding surface 66 adjacent the end 84, for example, could vary from the radial deformation along the end 86 by up to 0.0005 inch per 100 psi of radial pressure and the tape winding surface 66 would be characterized as having approximately uniform radial deformation across the tape winding surface 66. In addition, the present invention limits the non-uniform deformation of the tape-winding surface 66 to approximately 0.00004 inch per 100 psi of radial pressure. In a more preferred embodiment, “approximately uniform radial deformation” is defined to mean a variation in deformation of less than 0.0003 inch per 100 psi of radial pressure. Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

For example, while the tape reel assembly of the present invention has been described as being part of a data storage tape cartridge, other tape drive system applications are equally applicable. Thus, the tape reel assembly of the present invention can be provided as part of a tape drive and otherwise used to wind and unwind storage tape within the tape drive.

1. A tape reel assembly for use in a tape drive system for winding and unwinding storage tape, the tape reel assembly comprising:
a hub including:
a cylindrical core;
an annular wall co-axially disposed exterior to and separated from the cylindrical core, the annular wall defining a tape winding surface; and
a web extending between the annular wall and the cylindrical core, the web defining a first surface and a second surface;
wherein at least one of the first surface and the second surface is shaped to approximate a sinusoid in radial cross-section.

2. The tape reel assembly of claim 1, wherein the web undulates across a width of the annular wall to support the tape-winding surface.

3. The tape reel assembly of claim 1, wherein the web undulates across a distance less than a width of the annular wall to support the tape winding surface.

4. The tape reel assembly of claim 1, wherein the hub is configured such that when under a compressive radial load, the tape winding surface exhibits approximately uniform radial deformation.

5. The tape reel assembly of claim 1, wherein the web has a thickness defined by a distance between the first surface and the second surface, the thickness approximately constant across the web.

6. The tape reel assembly of claim 5, wherein the web thickness is in the range of 0.005 to 0.1 inch.

7. The tape reel assembly of claim 5, wherein the web thickness is in the range of 0.02 to 0.08 inch.

8. The tape reel assembly of claim 5, wherein the web thickness is approximately 0.04 inch.

9. The tape reel assembly of claim 1, wherein the web has a thickness defined by a distance between the first surface and the second surface, the thickness being non-constant across the web.

10. The tape reel assembly of claim 1, wherein the first and second surfaces are shaped to approximate a sinusoid in radial cross-section.

11. The tape reel assembly of claim 10, wherein the first and second surfaces are shaped to define a sawtooth pattern.

12. The tape reel assembly of claim 1, wherein the annular wall has a width defined by a distance between a first end and a second end of the annular wall, and further wherein the web undulates between the first and second ends.

13. The tape reel assembly of claim 12, wherein the web defines an amplitude of undulation at the annular wall equal to one-half the width of the annular wall.

14. The tape reel assembly of claim 12, wherein the web defines an amplitude of undulation at the annular wall of less than one-half the width of the annular wall.

15. The tape reel assembly of claim 12, wherein the web defines an amplitude of undulation at the cylindrical core equal to one-half the width of the annular wall.

16. The tape reel assembly of claim 12, wherein the web defines an amplitude of undulation at the cylindrical core in the range of 0 to one-half the width of the annular wall.

17. The tape reel assembly of claim 1, further comprising an upper flange and a lower flange, the upper flange and the lower flange extending in a radial fashion from opposing sides of the hub, respectively.

18. A data storage tape cartridge comprising:
a housing defining an enclosed region;
at least one tape reel assembly rotatably disposed within the enclosed region and including a hub having:
a cylindrical core;
an annular wall co-axially disposed exterior to and separated from the cylindrical core, the annular wall having a first end and a second end and defining a tape winding surface;
a web extending between the annular wall and the cylindrical core; and
storage tape selectively wound about the tape-winding surface;
wherein the web is shaped to approximate a sinusoid in radial cross-section.

19. The data storage tape cartridge of claim 18, wherein the web undulates between the ends of the annular wall to support the tape-winding surface.

20. The data storage tape cartridge of claim 18, wherein the hub is configured such that when under a compressive radial load, the tape winding surface exhibits approximately uniform radial deformation.

21. The data storage tape cartridge of claim 18, wherein the web has a thickness defined by a distance between a first surface and a second surface of the web, the thickness in the range of 0.005 to 0.1 inch.

22. A method of manufacturing a tape reel assembly for use in a tape drive system for winding and unwinding storage tape, the method comprising:
forming a cylindrical core;
forming an annular wall co-axially disposed exterior to and separated from the cylindrical core, the annular wall having a first end and a second end and defining a tape winding surface;
forming a web extending between the cylindrical core and the annular wall, the web defining a first surface and a second surface; and
configuring at least one of the first surface and the second surface of the web to undulate between the first and second ends of the annular wall.
